(19) United States
(12) Patent Application Publication
(10) Pub. No.: US 2025/0310865 A1
(43) Pub. Date: Oct. 2, 2025

(54) ROAMING OPTIMIZATION

(71) Applicant: DISH Wireless L.L.C., Englewood, CO (US)

(72) Inventor: Xiaowen Robinson, Great Falls, VA (US)

(21) Appl. No.: 18/623,813

(22) Filed: Apr. 1, 2024

(51) Int. Cl. H04W 48/16; H04L 9/40; H04W 84/04

(52) U.S. Cl. CPC H04W 48/16; H04L 63/0281; H04W 84/042

(57) ABSTRACT

A disclosed method may include (i) receiving, by a home security edge protection proxy at a home cellular network from a visited security edge protection proxy at a visited cellular network, a discovery request from a first network function located at the visited cellular network to discover a second network function within the home cellular network and (ii) inferring, by a component of the home cellular network in response to the discovery request, that the discovery request was sent from a sending region of the visited cellular network despite the discovery request failing to indicate the sending region in a preferred locality field of the discovery request.

### BRIEF SUMMARY

This disclosure is generally directed to systems, methods, and computer-readable media relating to roaming optimization. As understood by those having skill in the art, network communications generally proceed better when the shortest path is used for transmitting information between two or more paths under consideration. For example, if a device in Texas seeks for a task to be performed and one candidate device for performing the task is located in Texas and another candidate device for performing the task is located in Canada, then it can be preferred for the device in Texas to perform the task, all else being equal.

In some telecommunication networks, a requesting device can facilitate the selection of a more local destination by indicating its own locality information. For example, in a fifth-generation cellular telecommunication network, a network function can register its own locality information with a network repository function. Generally speaking, the network repository function can maintain a centralized or canonical index of all of the various network functions on the network, their localities, their available services, and/or their respective statuses. By indicating its own locality information, the network function may help facilitate the network repository function in matching the network function with other network functions located in the same locality or region.

In the context of a roaming scenario between two mobile network operators, however, the benefits of the facilitation process outlined above can start to break down. Whereas a single mobile network operator may have the option to have its network functions report the locality information to the network repository function, in the context of a roaming scenario one of the two networks involved (i.e., the home network and the visited network) may prevent the other one of these two networks from receiving this locality information. For example, one mobile network operator may fail to support this locality feature or may have disabled it. This can happen even in scenarios where the other mobile network operator would desire to learn this information or would potentially benefit from learning this information. Additionally, or alternatively, in some scenarios one mobile network operator may be prevented from having visibility into the locality information of the network function in the other one of the two networks. This can happen, for example, according to a topology hiding procedure whereby one mobile network operator hides one or more instances of topology information about its own network from the other network. In more specific examples, a security edge protection proxy at one fifth-generation network may perform the topology hiding procedure to remove or prevent visibility into the locality of a requesting network function.

This disclosure describes various technologies and embodiments that can help to overcome one or more of the obstacles outlined above. In particular, the various technologies of this disclosure can help to address scenarios whereby locality information can be missing when received by a receiving network in a roaming scenario. The receiving network can nevertheless infer locality information or an approximation of the locality information using one or more of multiple different techniques, as discussed in more detail below. Upon successfully performing one or more of these techniques for inferring the locality information, the receiving network can then intelligently apply the inferred locality information to appropriately match network functions together such that they are closer or such that they belong to matching regions. These beneficial results and/or other improvements will generally be discussed in greater detail below in the detailed description and the discussion of the corresponding FIGS. 1-9.

In some examples, a method include (i) receiving, by a home security edge protection proxy at a home cellular network from a visited security edge protection proxy at a visited cellular network, a discovery request from a first network function located at the visited cellular network to discover a second network function within the home cellular network, (ii) inferring, by a component of the home cellular network in response to the discovery request, that the discovery request was sent from a sending region of the visited cellular network despite the discovery request failing to indicate the sending region in a preferred locality field of the discovery request, and (iii) transmitting, by the home security edge protection proxy at the home cellular network to the first network function located at the visited cellular network in response to the discovery request and based on inferring that the discovery request was sent from the sending region of the visited cellular network, a discovery response that indicates a highest priority for at least one candidate network function located at a receiving region of the home cellular network that matches the sending region of the visited cellular network from among a set of multiple pairs of matching regions between the home cellular network and the visited cellular network.

In some examples, inferring, by the component of the home cellular network in response to the discovery request, that the discovery request was sent from the sending region of the visited cellular network despite the discovery request failing to indicate the sending region in the preferred locality field of the discovery request comprises the component of the home cellular network inferring the sending region based on analysis of an Internet Protocol address of the home security edge protection proxy.

In some examples, the method further comprises the component of the home cellular network inserting an identifier of the sending region into the discovery request such that a modified discovery request is generated.

In some examples, the component of the home cellular network inserts the identifier of the sending region into the preferred locality field of the discovery request such that the modified discovery request is generated.

In some examples, the component of the home cellular network inserts the identifier of the sending region into the discovery request such that the modified discovery request is generated at least in part by inserting an identifier of a home security edge protection proxy region where the home security edge protection proxy is located into the discovery request such that the modified discovery request is generated based on an inference that the sending region and the home security edge protection proxy region match each other.

In some examples, the home security edge protection proxy at the home cellular network inserts the identifier of the sending region into the discovery request such that the modified discovery request is generated.

In some examples, the home security edge protection proxy at the home cellular network forwards the modified discovery request to a home network repository function within the home cellular network.

In some examples, the home network repository function within the home cellular network generates the discovery response in response to receiving the modified discovery request.

In some examples, the home cellular network checks whether an original region already indicated in a preferred locality field of the discovery request matches the sending region of the visited cellular network that the component of the home cellular network infers the discovery request was sent from.

In some examples, the component of the home cellular network overwrites the original region with the sending region in the discovery request based on a conclusion that the original region already indicated in the preferred locality field in the discovery request does not match the sending region of the visited cellular network that the component of the home cellular network infers the discovery request was sent from.

In some examples, inferring, by the component of the home cellular network in response to the discovery request, that the discovery request was sent from the sending region of the visited cellular network despite the discovery request failing to indicate the sending region in the preferred locality field of the discovery request comprises the component of the home cellular network inferring the sending region based on analysis of an Internet Protocol address of the visited security edge protection proxy.

In some examples, the first network function initially sends the discovery request to a visited network repository function in the visited cellular network and the visited network repository function in the visited cellular network indicates, in response to receiving the discovery request, that the visited network repository function cannot properly answer the discovery request.

In some examples, the visited network repository function in the visited cellular network redirects the discovery request to a home network repository function in the home cellular network and the visited security edge protection proxy at the visited cellular network, in response to the visited network repository function in the visited cellular network redirecting the discovery request to the home network repository function in the home cellular network, forwards the discovery request to the home security edge protection proxy at the home cellular network.

In some examples, the set of multiple pairs of matching regions comprises W2 or west, E2 or central, and E1 or east.

In some examples, the home cellular network maintains a respective security edge protection proxy for each region in the set of multiple pairs of matching regions and the visited cellular network maintains a respective security edge protection proxy for each region in the set of multiple pairs of matching regions.

In some examples, each respective security edge protection proxy in the set of multiple pairs of matching regions in the home cellular network connects to all respective security edge protection proxies in the set of multiple pairs of matching regions in the visited cellular network, and each respective security edge protection proxy in the set of multiple pairs of matching regions in the visited cellular network connects to all respective security edge protection proxies in the set of multiple pairs of matching regions in the home cellular network.

In some examples, a system includes at least one physical computing processor of a computing device and a non-transitory computer-readable medium that has instructions stored thereon that, when executed by the at least one physical computing processor, cause the computing device to perform operations comprising: (i) receiving, by a home security edge protection proxy at a home cellular network from a visited security edge protection proxy at a visited cellular network, a discovery request from a first network function located at the visited cellular network to discover a second network function within the home cellular network, (ii) inferring, by a component of the home cellular network in response to the discovery request, that the discovery request was sent from a sending region of the visited cellular network despite the discovery request failing to indicate the sending region in a preferred locality field of the discovery request, and (iii) transmitting, by the home security edge protection proxy at the home cellular network to the first network function located at the visited cellular network in response to the discovery request and based on inferring that the discovery request was sent from the sending region of the visited cellular network, a discovery response that indicates a highest priority for at least one candidate network function located at a receiving region of the home cellular network that matches the sending region of the visited cellular network from among a set of multiple pairs of matching regions between the home cellular network and the visited cellular network.

In some examples, a non-transitory computer-readable medium that has instructions stored thereon that, when executed by at least one physical computing processor, cause a computing device to perform operations comprising: (i) receiving, by a home security edge protection proxy at a home cellular network from a visited security edge protection proxy at a visited cellular network, a discovery request from a first network function located at the visited cellular network to discover a second network function within the home cellular network, (ii) inferring, by a component of the home cellular network in response to the discovery request, that the discovery request was sent from a sending region of the visited cellular network despite the discovery request failing to indicate the sending region in a preferred locality field of the discovery request, and (iii) transmitting, by the home security edge protection proxy at the home cellular network to the first network function located at the visited cellular network in response to the discovery request and based on inferring that the discovery request was sent from the sending region of the visited cellular network, a discovery response that indicates a highest priority for at least one candidate network function located at a receiving region of the home cellular network that matches the sending region of the visited cellular network from among a set of multiple pairs of matching regions between the home cellular network and the visited cellular network.

### BRIEF DESCRIPTION OF THE DRAWINGS

For a better understanding of the present invention, reference will be made to the following Detailed Description, which is to be read in association with the accompanying drawings:

FIG. 1 shows a flow diagram for a method relating to roaming optimization.

FIG. 2 shows a diagram of a hierarchical telecommunication network including national data centers, regional data centers, and breakout edge data centers.

FIG. 3 shows a series of three diagrams indicating how a network repository function may respond to respective different discovery requests from a network function.

FIG. 4 shows a diagram of connections between respective security edge protection proxies between a home cellular network and a visited cellular network.

FIG. 5 shows a timing diagram indicating how a series of messages may be transmitted as part of a discovery request and a corresponding discovery response procedure.

FIG. 6 shows a flow diagram for a method relating to roaming optimization in a first embodiment that relies on an Internet protocol address of a home security edge protection proxy.

FIG. 7 shows a diagram relating to a second embodiment that relies on a known region of a home security edge protection proxy.

FIG. 8 shows a diagram indicating how the network repository function may respond to a discovery request from a network function in the embodiment of FIG. 6 or FIG. 7, for example.

FIG. 9 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

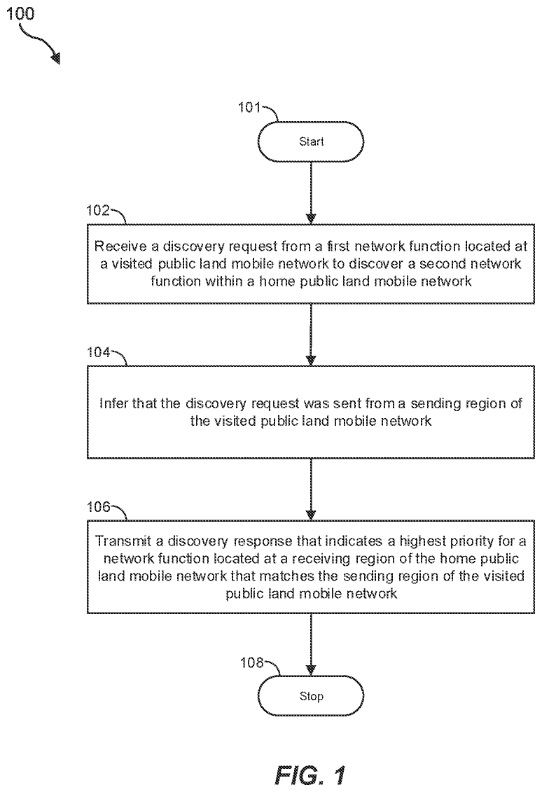

FIG. 1 shows a flow diagram for an example method 100 relating to roaming optimization. At step 101, method 100 may start or begin. At step 102, method 100 may include receiving, by a home security edge protection proxy at a home cellular network (for example, a home public land mobile network (PLMN)), from a visited security edge protection proxy at a visited cellular network (for example, a visited PLMN), a discovery request from a first network function located at the visited cellular network to discover a second network function within the home cellular network. At step 104, method 100 may include inferring, by a component of the home cellular network in response to the discovery request, that the discovery request was sent from a sending region of the visited cellular network despite the discovery request failing to indicate the sending region in a preferred locality field of the discovery request. At step 106, method 100 may include transmitting, by the home security edge protection proxy at the home cellular network to the first network function located at the visited cellular network in response to the discovery request and based on inferring that the discovery request was sent from the sending region of the visited cellular network, a discovery response that indicates a highest priority for at least one candidate network function located at a receiving region of the home cellular network that matches the sending region of the visited cellular network from among a set of multiple pairs of matching regions between the home cellular network and the visited cellular network. At step 108, method 100 may stop or conclude.

As used herein, the term “visited cellular network” or “visited network” can refer to the visited network in a roaming scenario, such as a visited public land mobile network, whereas the term “home cellular network” or “home network” can refer to the home network in the same roaming scenario, such as a visited public land mobile network. As used herein, the phrase “infer” can generally refer to the component of the home network overcoming an obstacle in terms of learning the sending region of the visited network by making one or more logical observations, inferences, and/or deductions. Generally speaking, these inferences can include inferring that the discovery request was sent from the same region as the security edge protection proxy at the visited network that sent the discovery request to the home network, as indicated by the Internet protocol address of the security edge protection proxy, and/or inferring that the discovery request was sent from a matching region that matches a region of the security edge protection proxy at the home network that received the discovery request from the visited network. Similarly, as further discussed above, the obstacle that the component of the home network overcomes can correspond, for example, to the visited network failing to support locality-based query or visibility with respect to the home network and/or the visited network performing one or more topology hiding features that effectively disguises, and/or prevents visibility into, the preferred locality of the first network function issuing the discovery request. In some specific examples, the visited network can perform topology hiding by stripping a value from the preferred locality field of a discovery request or otherwise obfuscating this value. Moreover, as used herein, the phrase “roaming optimization” can generally refer to one or more of the technologies described herein improving roaming procedures and/or bringing them closer to optimal, without necessarily achieving strict optimization or perfection, as understood by those having skill in the art.

As used herein, the term “a component of the home cellular network” can generally refer to any suitable component or network function of the home network for performing the corresponding step, act, and/or procedure, consistent with the discussion below. Depending on the circumstances, the component may correspond to a security edge protection proxy, a network repository function, and/or one or more other remaining network functions on the home network, for example. As used herein, the term “discovery request” can include an NFDiscovery or NF Discovery request according to cellular fifth generation technologies, protocols, and/or specifications, including TS 29.510 (“5G System; Network function repository services”) and TS 23.502 (“Procedures for the 5G System (5GS)”), for example.

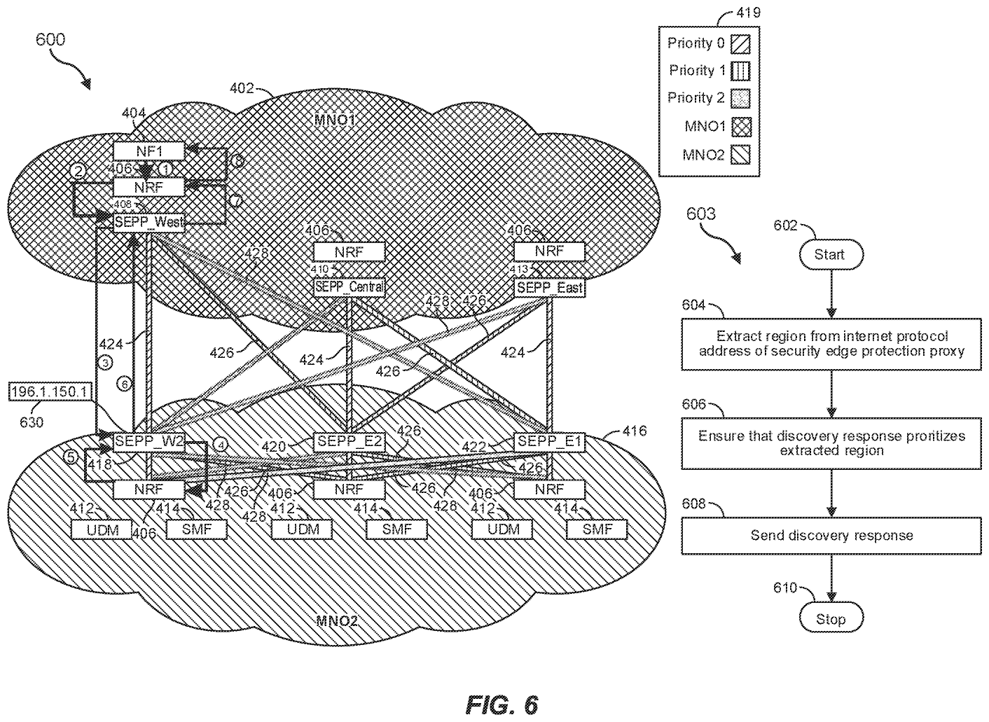

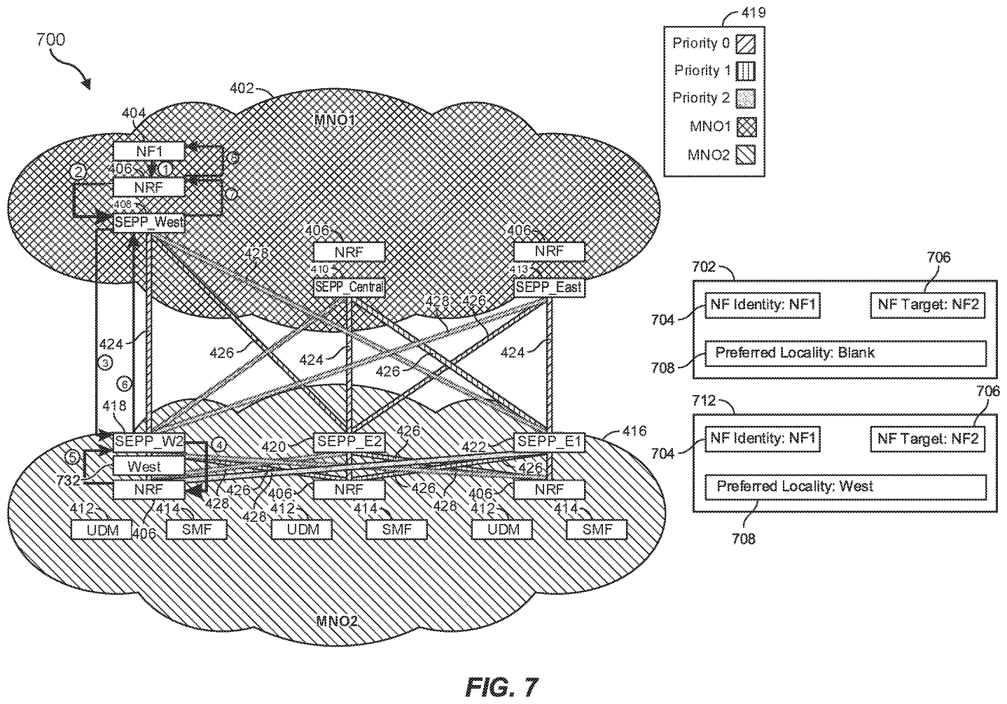

As used herein, the phrase “inferring” can generally referring to performing one or more acts to understand or estimate which particular sending region, from among multiple such regions, in the visited network the discovery request came from or originated from, despite the preferred locality field of the discovery request failing to indicate the particular sending region. Illustrative examples of such inference procedures are discussed below in connection with FIGS. 6-7.

Method 100 can generally be interpreted in the context of a roaming scenario between a home network and a visited network, where the home network and the visited network form matching pairs of regions. In various examples, the home cellular network maintains a respective security edge protection proxy for each region in the set of multiple pairs of matching regions and the visited cellular network maintains a respective security edge protection proxy for each region in the set of multiple pairs of matching regions. Furthermore, in these examples, each respective security edge protection proxy in the set of multiple pairs of matching regions in the home cellular network connects to all respective security edge protection proxies in the set of multiple pairs of matching regions in the visited cellular network, and each respective security edge protection proxy in the set of multiple pairs of matching regions in the visited cellular network connects to all respective security edge protection proxies in the set of multiple pairs of matching regions in the home cellular network.

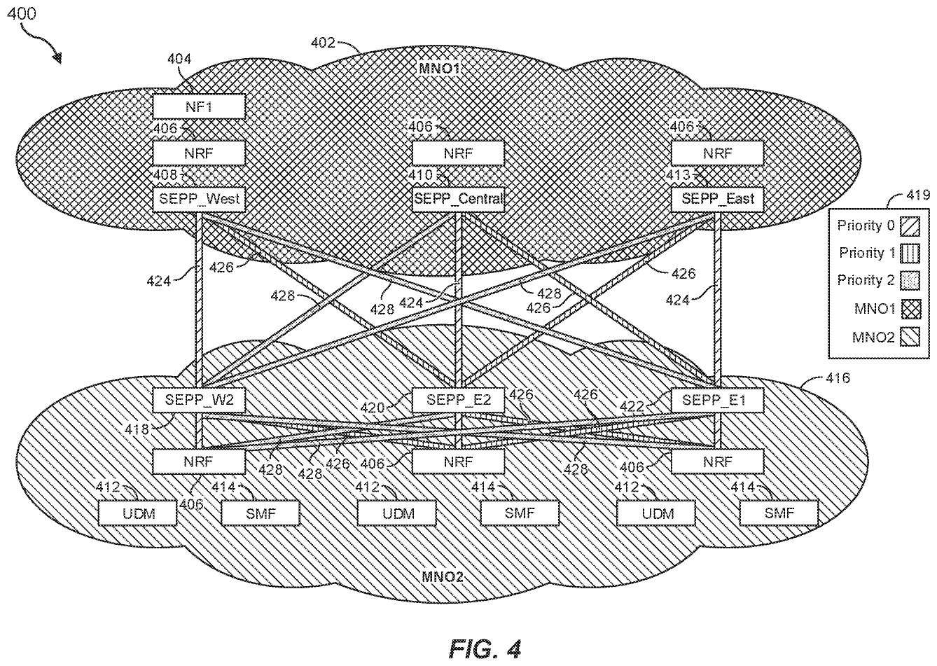

By way of illustrative example, and as discussed in more detail below, mobile network operator 402 corresponding to the visited network can include three separate regions with three separate security edge protection proxies, including a security edge protection proxy 408, a security edge protection proxy 410, and a security edge protection proxy 413, as shown. Similarly, in a symmetrical manner, mobile network operator 416 corresponding to the home network includes three separate regions with three separate security edge protection proxies, including a security edge protection proxy 418, a security edge protection proxy 420, and a security edge protection proxy 422. Moreover, as highlighted within the illustrative example of this figure, the security edge protection proxies of the visited network and the security edge protection proxies of the home network form matching pairs such that a security edge protection proxy within one network is generally connected, across a primary connection, to the security edge protection proxy of the other network that is closest to it and/or that is located within the same or matching region, as shown. Accordingly, the method phrase “matches the sending region of the visited cellular network from among a set of multiple pairs of matching regions between the home cellular network in the visited cellular network” can generally be interpreted within the context of this example for illustrative purposes. The phrase “matching” can also be interpreted consistent with the discussion of primary priority links, secondary priority links, and tertiary priority links below with respect to FIG. 4 such that matching regions or matching security edge protection proxies are those regions or security edge protection proxies connected across primary priority links.

To elaborate, a region of security edge protection proxy 408 (“west” or W2) generally matches a region of security edge protection proxy 418, a region of security edge protection proxy 410 (“central” or E2) generally matches a region of security edge protection proxy 420, and a region of security edge protection proxy 413 (“east” or “E1”) generally matches a region of security edge protection proxy 422, as shown. Thus, in the context of performing method 100, this method can involve ensuring that a discovery response from the home network indicates the west region as having the highest priority based on an inference that the corresponding discovery request was issued by security edge protection proxy 408 and/or received by security edge protection proxy 418. Method 100 will operate in a parallel manner for the central or E2 region and/or the east or E1 region, as discussed above and as further illustrated within the example of FIG. 4. Generally speaking, the regions may include at least W2 or west, E2 or central, and E1 or east.

Those having skill in the art can understand that these particular regions, within the example of this figure, can correspond to regions within AMAZON AWS without this disclosure being necessarily limited to that particular platform or those particular regions. Rather, method 100 and/or the various technologies outlined within this disclosure may apply within any suitable roaming scenario between two mobile network operators with matching regions analogous to that outlined within FIG. 4 and as discussed in more detail below. Similarly, those having skill in the art will understand that, although three pairs of matching regions are shown within the example of FIG. 4, this example is not limiting in terms of the number of regions and, in other examples, any suitable number of regions may be used and covered by the technology of this disclosure.

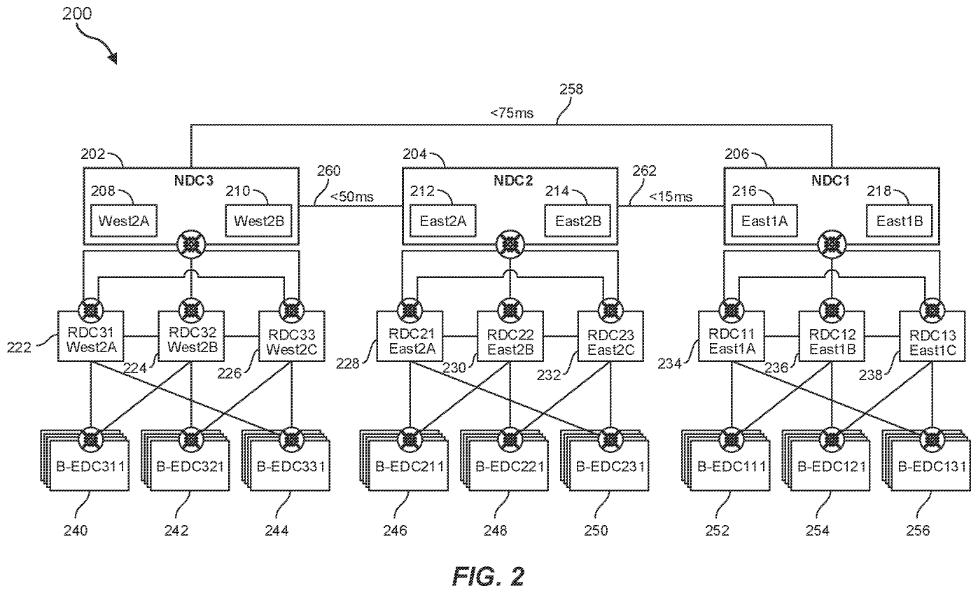

FIG. 2 shows a diagram 200 of a hierarchical telecommunication network including national data centers, regional data centers, and breakout edge data centers. More specifically, in this example diagram 200 shows national data centers 202-206, regional data centers 222-238, and breakout edge data centers 240-256. An indicator 258 highlights to the reader how a network transition time from one national data center 206 to national data center 202 may be less than 75 ms. Similarly, an indicator 260 highlights to the reader how a network transmission time from national data center 204 to national data center 202 may be less than 50 ms. Furthermore, an indicator 262 highlights to the reader how a network transmission time from national data center 206 to national data center 204 may be less than 15 ms. In various examples, one or more of the networks described herein, including the network of diagram 200, may include a generation or later generation cellular telecommunication network.

Diagram 200 provides a context of a single mobile network operator, outside of the roaming context, in which a network function consumer may use preferred locality query parameter, via the network function repository function, to select the ideal network function producer based on its registered locality and other matching profile information. All of these network functions on the same network of diagram 200 may register their profiles with the network repository function, which can maintain a central or canonical database indicating their respective localities. In such scenarios, there may be no specific obstacle preventing any one network function consumer from having visibility into, or learning, the locality of a network function producer that the network function consumer would otherwise appropriately use as its target.

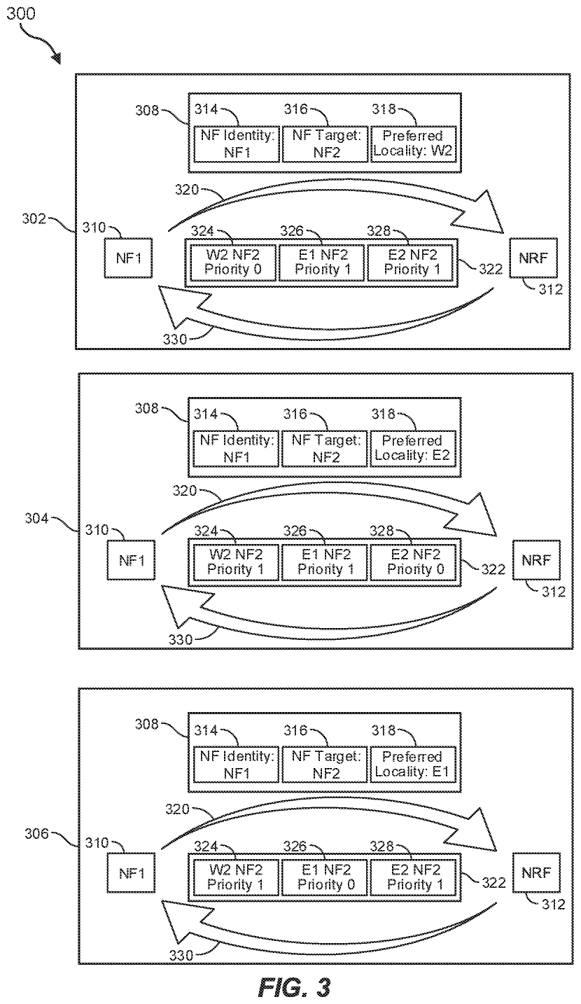

FIG. 3 shows a series 300 of three diagrams, including a diagram 302, a diagram 304, and a diagram 306, indicating how a network repository function may respond to respective different discovery requests from a network function. In each one of these diagrams, an arrow 320 indicates a discovery request transmitted from network function 310 to network repository function 312. Above each instance of arrow 320, series 300 further illustrates the contents of a corresponding discovery request 308, which generally includes a network function identity field 314, a network function target field 316, and a preferred locality field 318, as shown. Network function identity field 314 generally indicates the identity of the network function consumer that is issuing the discovery request and/or indicates a type of service that the network function consumer provides. Network function target field 316 generally indicates a type of service that the network function consumer is requesting to be performed by a network function producer, where the network function consumer is seeking to learn the identities and/or contact information for candidate network function producers that are available to perform such a task. Lastly, preferred locality field 318 generally indicates a preference, from the perspective of the network function consumer, regarding which locality the network function consumer would like for the network function producer to be located. Generally speaking, it can be beneficial for the network function producer to be located within the same region or locality as the network function consumer, as discussed above. Accordingly, in some examples the network function consumer can specify its own locality within preferred locality field 318. The network function can also register itself as a consumer using its own locality or locality tag (e.g., “W2” or west) with the network repository function as part of the registration process prior to the discovery request.

Whereas arrow 320 indicated the discovery request issued from network function 310 to network repository function 312, a corresponding arrow 330 indicates the discovery response that is issued in response to this discovery request by network repository function 312 to network function 310. Similarly, above arrow 330 within diagram 302 is included a discovery response 322, which further indicates a network function field 324, a network function field 326, and a network function field 328. Each one of these network function fields indicates a name or type of the corresponding network function producer, a region or locality in which the network function producer is located, and/or a level of priority that the network function repository has indicated for the respective network function producer based on the value that network function 310 specified within preferred locality field 318.

The diagrams of series 300 can generally correspond to the single mobile network operator embodiment of diagram 200 outside of the roaming context, and as further discussed above. In these scenarios, the network function consumer may have no obstacle to its visibility into the locality of one or more network function producers that it seeks to discover. Accordingly, in diagram 302, discovery response 322 indicates a priority of zero or highest priority for network function field 324 with a region of “W2” that matches the region within preferred locality field 318. The examples of diagram 304 and diagram 306 indicate matching regions between preferred locality field 318 in the discovery request and the locality information of the corresponding network function within discovery response 322, respectively, as shown.

FIG. 4 shows a diagram 400 of connections between respective security edge protection proxies between a home cellular network and a visited cellular network. As first discussed above, the home cellular network may correspond to mobile network operator 416 and the visited cellular network may correspond to a mobile network operator 402. Both of these networks may include three separate regions, as shown. Moreover, each of these regions, within each of these networks, may include a respective network repository function. In particular, mobile network operator 402 may include three separate instances of a network repository function 406 sharing common or replicated databases. Diagram 400 also illustrates how various network functions may be associated with different ones of these regions and, therefore, correspond with the respective network repository function within each region. For example, network function 404 may be associated with the “west” region of the visited network of mobile network operator 402 and network function 404 may, therefore, communicate primarily with network repository function 406 in that particular region as part of one or more network procedures, including the discovery procedures whereby network function 404 may act as a consumer seeking one or more network function producers, as discussed in more detail below.

Diagram 400 also shows illustrative examples of network functions included within mobile network operator 416. For example, diagram 400 shows three instances of a unified data management 412 associated with each of the three regions within mobile network operator 416, respectively. Diagram 400 also shows three instances of session management function 414 associated with each of the three regions within mobile network operator 416. Similar to mobile network operator 402, mobile network operator 416 also includes a respective instance of network repository function 406 for each of the three regions within mobile network operator 416.

Diagram 400 also shows instances of a primary priority link 424, a secondary priority link 426, and a tertiary priority link 428. The different levels of priority for these respective links are indicated within a corresponding legend 419, which maps corresponding types of coloring or hatching to different levels of priority, as shown. By applying legend 419, the reader can ascertain that diagram 400 shows a configuration in which there is a primary priority link between security edge protection proxies of the same region or matching regions, while at the same time each security edge protection proxy also forms secondary priority and/or tertiary priority links with one or more remaining ones of the security edge protection proxies of the other network. The use of primary priority links or connections helps to follow the insight outlined above whereby it is beneficial and/or more efficient for network functions to communicate with other network functions that are located within the same or matching regions rather than traveling longer distances or communicating across regions. The use of these priority levels with the links between the security edge detection proxies helps to ensure that the primary, default, majority, and/or predominant majority of network traffic from one security edge protection proxy is directed to its matching security edge protection proxy in the same corresponding region across the respective primary priority link. In the case of network congestion and/or in the case of a security edge protection proxy going off-line, then a secondary priority link and/or a tertiary priority link may be utilized, but in various examples these scenarios would be relatively rare while leaving the predominant majority of network traffic to proceed across primary priority links, as discussed above.

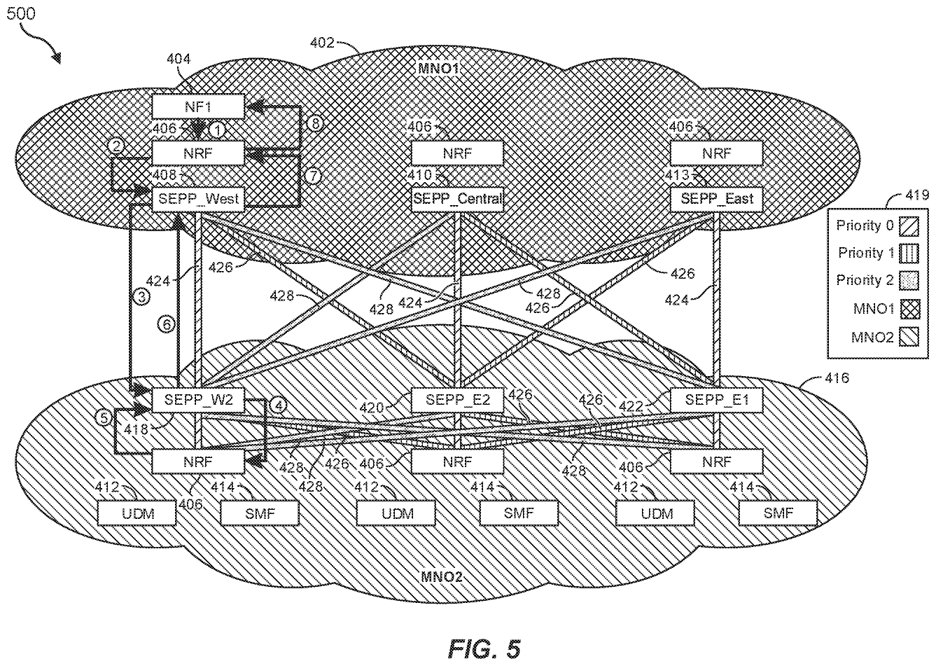

FIG. 5 shows a timing diagram 500 indicating how a series of messages may be transmitted as part of a discovery request and a corresponding discovery response procedure. At step one, network function 404 may correspond to a first network function or a network function consumer, and network function 404 may receive or determine an indication to discover a second network function, such as a network function producer that can perform a task for network function 404. Accordingly, network function 404 may seek to discover a second network function that can suitably perform the task on behalf of network function 404. Network function 404 may therefore send a discovery request at step one to network repository function 406 within the same region of mobile network operator 402.

Nevertheless, network repository function 406 within mobile network operator 402 may not be able to provide an appropriate or satisfactory answer in response to the discovery request. Accordingly, at step two, network repository function 406 may determine that it cannot appropriately or satisfactorily answer the discovery request and/or that it does not possess the particular information that network function 404 is seeking. More specifically, network repository function 406 may ascertain that the discovery request is seeking information regarding network functions that are maintained with a distinct network repository function on a different cellular network, and in particular mobile network operator 416. For example, the discovery request itself may specify or indicate an identity of mobile network operator 416 as the cellular network where the target network function would be located. In other words, to describe this scenario in the terms of method 100, the first network function initially sends the discovery request to a visited network repository function in the visited cellular network and the visited network repository function in the visited cellular network indicates, in response to receiving the discovery request, that the visited network repository function cannot properly answer the discovery request.

In the roaming context outlined above and shown within timing diagram 500, mobile network operator 402 and mobile network operator 416 generally communicate with each other across pairs of security edge protection proxies. Accordingly, after network repository function 406 in the visited network determines that it cannot satisfactorily answer the discovery request and/or does not contain the answer, the discovery request may be redirected to mobile network operator 416, and this redirected discovery request will generally be sent between security edge protection proxies. For this reason, timing diagram 500 shows that, as part of step two, network repository function 406 in mobile network operator 402 forwards the discovery request to security edge protection proxy 408. In other words, to describe the scenario in the terms of method 100, the visited network repository function in the visited cellular network redirects the discovery request to a home network repository function in the home cellular network, and the visited security edge protection proxy at the visited cellular network, in response to the visited network repository function in the visited cellular network redirecting the discovery request to the home network repository function in the home cellular network, forwards the discovery request to the home security edge protection proxy at the home cellular network. As used herein, the terms “visited security edge protection proxy” and “home security edge protection proxy” can generally refer to the security edge protection proxies in the visited network and the home network, respectively, and communicating according to method 100 in a roaming scenario.

Similarly, at step three, security edge protection proxy 408 forwards the discovery request to security edge protection proxy 418. At step four, security edge protection proxy 418 forwards the discovery request to network repository function 406 that is associated with the west region, as shown. In other words, method 100 can further include the home security edge protection proxy at the home cellular network forwarding the modified discovery request to a home network repository function within the home cellular network. Those having skill in the art will understand that the discovery request sent from security edge protection proxy 408 was received by security edge protection proxy 418, rather than a different instance of a security edge protection proxy within mobile network operator 416, due to the primary priority link between security edge protection proxy 408 and security edge protection proxy 418 (e.g., and/or due to the overlapping and/or geographical proximity between this region of mobile network operator 402 and the corresponding region of mobile network operator 416).

Network repository function 406 may actually contain the information that network function 404 is seeking due to the fact that network repository function 406 in mobile network operator 416 covers the same home network where the network function producer sought by network function 404 is located. Accordingly, at step five, network repository function 406 in this region of mobile network operator 416 may transmit the discovery response with an ultimate destination of network function 404 in mobile network operator 402. To describe the scenario in the terms of method 100, this method may further include the home network repository function within the home cellular network generating the discovery response in response to receiving the modified discovery request. Nevertheless, for this message to ultimately reach network function 404, the message must jump across various hops, in symmetry to the performance of steps 2-4, as discussed above. Accordingly, at step five, network repository function 406 may transmit the discovery response to security edge protection proxy 418. At step six, security edge protection proxy 418 may transfer the discovery response to security edge protection proxy 408. At step seven, security edge protection proxy 408 may forward the discovery response to network repository function 406. Lastly, at step eight, network repository function 406 may forward the discovery response to network function 404.

FIG. 6 shows a diagram 600 relating to roaming optimization in a first embodiment that relies on an Internet protocol address of a home security edge protection proxy. With respect to method 100, diagram 600 illustrates how the component of the home cellular network can infer the sending region based on analysis of an Internet Protocol address of the home security edge protection proxy. More specifically, whereas timing diagram 500 highlighted a path for network repository function 406 in the corresponding region of mobile network operator 416 to provide an appropriate discovery response to network function 404 in mobile network operator 402, timing diagram 500 did not necessarily indicate or reflect the obstacle that mobile network operator 402 may potentially present to the network repository function in terms of locality information. As discussed above, mobile network operator 402 may fail to support locality preference indication or the value of the query parameter preferred locality may not be formatted in the same convention as that of the home network. For example, mobile network operator 402 may apply one or more security or other policies that limits visibility into locality information, such as preventing one or more components of mobile network operator 416 from having visibility into such items of information. Additionally, or alternatively, mobile network operator 402 may also engage in one or more types of topology hiding. For example, mobile network operator 402 may optionally strip one or more items of locality information from the discovery request, such as stripping out or obfuscating the value from the preferred locality field of the discovery requests.

Furthermore, even if mobile network operator 402 does support the use of the preferred locality parameter, and even if mobile network operator 402 does not engage in topology hiding, it may nevertheless be the case that mobile network operator 402 and mobile network operator 416 use relevantly different identifiers, labels, tags, and/or naming conventions for regions or data centers that are essentially the same or that correspond to each other (e.g., correspond to each other geographically and/or correspond to each other according to primary priority links). For example, the tag “SEPP_West” is different than “SEPP_W2,” even in a scenario where these tags refer to essentially the same region as connected across primary priority links in a roaming context. These differences in naming conventions, even if they seem minor on the surface, can nevertheless create obstacles when mobile network operator 416 attempts to appropriately generate discovery responses that identify the highest priority network function producer at the correct locality. Accordingly, using one or more of the inference procedures discussed in this disclosure in the context of FIGS. 6-7 may help mobile network operator 416 identify the correct locality in its discovery responses despite such differences in naming conventions and/or without requiring a continuously perfect translation table or mapping between the naming conventions used by mobile network operator 402 and the naming conventions used by mobile network operator 416.

In a first embodiment, diagram 600 helps to illustrate how mobile network operator 416 may overcome one or more of the above-identified challenges by leveraging an Internet protocol address of a security edge protection proxy. In particular, mobile network operator 416 may leverage an Internet protocol address 630 of security edge protection proxy 418 within the “west” region. To elaborate, when network repository function 406 at step four receives the discovery request from security edge protection proxy 418, the discovery request message, as formatted according to the Internet protocol, will indicate Internet protocol address 630. The discovery request will indicate Internet protocol address 630 even if one or more components, Internet protocol addresses, and/or topology components of the visited network remain hidden and/or obfuscated from the perspective of mobile network operator 416. Accordingly, the component of the home network, such as network repository function 406, can overcome a failure of the discovery request to indicate a preferred locality and/or failure of the discovery request to indicate the sending region where the discovery request actually originated from by using, instead, Internet protocol address 630.

As understood by those having skill in the art, one or more aspects of geographic and/or proximity information can be extracted from one or more of the various fields of the Internet protocol address according to various techniques. For example, translation tables or databases may maintain mappings between Internet protocol address sets and/or subsets and corresponding geographic identifiers. Accordingly, one or more aspects of the Internet protocol address may reveal information regarding the sending region from which the discovery request originated. This is especially true in scenarios where the discovery request was transmitted across a primary priority link, as discussed above, which can correspond to the regular or default scenario (e.g., outside of a failover scenario).

Diagram 600 also includes a flow diagram for a method 603 corresponding to the first embodiment outlined above in connection with Internet protocol address 630. At step 602, method 603 may start or begin. At step 604, the component of the home network such as network repository function 406 may extract one or more items of information from the Internet protocol address of the home security edge protection proxy. At step 606, the component of the home network may ensure that the discovery response issued from the home network in response to the discovery request indicates a highest level of priority for one or more network functions having the same or matching locality as extracted or indicated by Internet protocol address 630. In some examples, the component of the home network may correspond to the network repository function in the home network, such as the network repository function for the region where the discovery request was received in the home network, as shown in diagram 600. By way of illustrative example, in a scenario where network repository function 406 is providing a list of unified data management functions and/or session management functions, the network repository function 406 may specify the instances of unified data management function and/or session management function 414 that are associated with the same region or matching region indicated by Internet protocol address 630. For example, if the Internet protocol address indicates the “west” region of the home network, then the component of the home network may list as the highest priority one or more instances of the unified data management function and/or session management function that are also located within the west region of the home network. Accordingly, at step 608, method 603 can include sending the discovery response, which can indicate the highest priority for the region of the home network that matches the sending region of the discovery request, as indicated by Internet protocol address 630. At step 610, method 603 may stop or conclude.

FIG. 7 shows a diagram 700 relating to a second embodiment that relies on a known region of a home security edge protection proxy. Diagram 700 substantially parallels diagram 600, except that the embodiment of diagram 700 uses an inference technique that is based on a region of the home security edge protection proxy rather than Internet protocol address 630. In other words, although both diagram 600 and diagram 700 focus upon location information describing a location of the home security edge protection proxy, diagram 600 focuses upon the Internet protocol address associated with the home security edge protection proxy whereas method 700 focuses upon known locality of the home security edge protection proxy. Thus, in diagram 600, security edge protection proxy 418 can operate normally while network repository function 406 modifies otherwise normal operations by analyzing Internet protocol address 630, whereas in diagram 700 network repository function 406 can operate normally while security edge protection proxy 418 modifies otherwise normal operations by inserting the indication of its known locality within the preferred locality field of the discovery request.

According to the embodiment of diagram 700, the component of the home network may insert a preferred locality parameter and/or a value into the preferred locality field of the discovery request as received by security edge protection proxy 418. For this reason, diagram 700 shows a discovery request 702, which indicates a format or content of the discovery request as it was received by the security edge protection proxy in the home network. Discovery request 702 may include a network function identity field 704, a network function target field 706, and a locality field 708, which can indicate a preferred locality that the network function issuing the discovery request would prefer for the target network function or network function producer to be located in. Diagram 700 shows that locality field 708 specifies a blank value rather than explicitly or otherwise indicating the sending region of the discovery request within mobile network operator 402. As further discussed above, locality field 708 may be blank or obfuscated in one or more of various ways due to a failure of mobile network operator 402 to support the locality feature and/or due to mobile network operator 402 engaging in one or more types of topology hiding.

To overcome the obstacle associated with the blank value within locality field 708 or with no locality field 708, the embodiment of diagram 700 can involve the component of the home network, such as security edge protection proxy 418 where the discovery request is received, inserting one or more types of locality information into the discovery request. With respect to method 100, diagram 700 illustrates one example of how method 100 can further include the component of the home cellular network inserting an identifier of the sending region into the discovery request such that a modified discovery request is generated. In particular, in the example of diagram 700, this insertion procedure can result in a modified discovery request, such as a modified discovery request 712, as shown. Diagram 700 shows that locality field 708 has been inserted, updated, or overridden such that the preferred locality field has been added or its blank or obfuscated value has been replaced by a value indicating the west region. To describe this scenario in the terms of method 100, the method can include the component of the home cellular network inserting or setting the preferred locality to the value of the identifier of the sending region in the discovery request such that the modified discovery request is generated.

In various examples, the component on the home network performing this insertion procedure can correspond to security edge protection proxy 418 where the discovery request was received. Accordingly, the security edge protection proxy where the discovery request was received will generally know and understand its own region. Moreover, the security edge protection proxy can furthermore expect that the traffic it receives will generally be received from the security edge protection proxy of the same or matching region within the visited network or mobile network operator 402 due to the primary priority link between security edge protection proxy 408 and security edge protection proxy 418, as shown. Accordingly, the security edge protection proxy at the home network can infer that the sending region of the discovery request within the visited network will generally be the same or matching region within the home network such that the security edge protection proxy and the home network benefit from inserting the known region of the home security edge protection proxy into the discovery request. Consequently, in these examples, method 100 can include inserting an identifier of a home security edge protection proxy region (see region 732) where the home security edge protection proxy is located into the discovery request such that the modified discovery request is generated based on an inference that the sending region and the home security edge protection proxy region match each other.

Additionally, or alternatively, security edge protection proxy 418 may extract the preferred locality from an Internet protocol address for security edge protection proxy 408 in the visited network. In some scenarios, the Internet protocol address for security edge protection proxy 408 in the visited network may provide a more accurate indication of the sending region (i.e., more accurate than the Internet protocol address or known locality of the home security edge protection proxy). These scenarios can include scenarios where security edge protection proxy 418 in the home network receives the discovery request across a secondary or tertiary link between non-matching regions of the home network and the visited network, as further discussed above.

Whereas the discussion above focused upon scenarios where the preferred locality field within the discovery request fails to indicate the sending region from which the discovery request was sent within the visited network, in other scenarios the home network may simply verify that the preferred locality field within the discovery request already includes or specifies the sending region. Upon making this verification, no further modification or deviation from normal discovery response and discovery request procedures would be necessary or suggested due to the desired region already being specified within the preferred locality field. In terms of method 100, in these scenarios, the home cellular network checks whether an original region already indicated in a preferred locality field of the discovery request matches the sending region of the visited cellular network that the component of the home cellular network infers the discovery request was sent from. In a first scenario, the home cellular network processes the discovery request without modification based on a conclusion that the original region already indicated in the preferred locality field in the discovery request matches the sending region of the visited cellular network that the component of the home cellular network infers the discovery request was sent from. In a second scenario, the component of the home cellular network overwrites the original region with the sending region in the discovery request based on a conclusion that the original region already indicated in the preferred locality field in the discovery request does not match the sending region of the visited cellular network that the component of the home cellular network infers the discovery request was sent from. In either scenario, the component of the home network applies a policy that ensures or guarantees that the discovery response indicates the highest priority for a region that matches the sending region that the component infers the discovery request was sent from, thereby helping to prevent scenarios where the discovery response indicates a highest priority for one or more regions that differ from this inferred sending region, which would inhibit the efficiencies that are associated with localization, as discussed above.

As outlined above, in some versions of the first embodiment of diagram 600, the component of the home network can include the network repository function of the home network and, in that case, the home security edge protection proxy may operate without modification. In other words, in this first embodiment the security edge protection proxy in the home network can operate normally by forwarding the unmodified discovery request to the network repository function, which can implement method 100 by analyzing and applying the Internet protocol address of the home security edge protection proxy, consistent with the discussion of diagram 600 above. In parallel, in some versions of the second embodiment of diagram 700, the component of the home network will be the home security edge protection proxy and, in that case, the network repository function may operate without modification. In other words, the network repository function in the home network can proceed normally after the home security edge protection proxy implements method 100 by modifying the discovery request to generate modified discovery request 712 (e.g., by inserting its known locality and/or by inserting the locality indicated by the Internet Protocol address of the visited security edge protection proxy), as further discussed above.

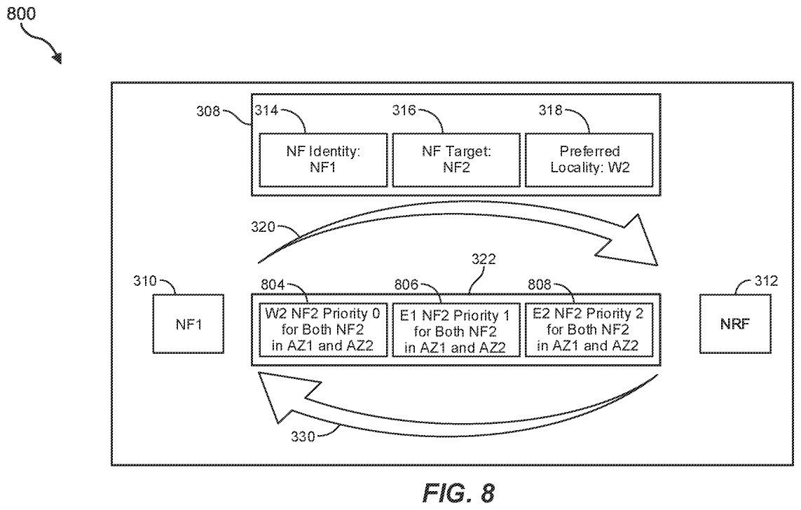

FIG. 8 shows a diagram 800 indicating how the network repository function may respond to a discovery request from a network function in the embodiment of FIG. 6 or FIG. 7, for example. Diagram 800 therefore parallels the diagrams of series 300 in that both of these outline discovery requests and discovery responses. Diagram 800 differs from the diagrams of series 300 in the sense that the diagrams of series 300 describe normal discovery request and discovery response procedures in the non-roaming context of a single home network without the obstacles to understanding the sending region of a discovery request and, therefore, without any need or indication to overcome those obstacles. In contrast, diagram 800 outlines discovery request and discovery response procedures consistent with the embodiment of diagram 600 and the embodiment of diagram 700 in which one or more obstacles to understanding the sending region of the discovery request are present due to the roaming context in which the discovery requested discovery response procedures are being performed as explained further above.

Diagram 800 repeats discovery request 308 including network function identity field 314, target field 316, and preferred locality field 318. Diagram 800 updates discovery response 322 with a network function field 804, a network function field 806, and a network function field 808. As in the diagrams of series 300, the locality indicated within preferred locality field 318 matches the highest priority (i.e., zero according to the priority naming convention in this context) of network function field 804 and its corresponding region of “W2.” In the example of diagram 800, network function field 804 may indicate the highest priority for two separate instances of the target network function corresponding to both of a first availability zone and a second availability zone, where each region of the home network has two separate availability zones, each of which has one of these target network functions. By way of illustrative example, diagram 800 can correspond to a scenario where an access and mobility management function in the visited network is attempting to discover a unified data management network function in the home network.

Another difference between the diagrams of series 300 and diagram 800 is reflected in the fact that, although the diagrams of series 300 use only secondary priority for the two network functions outside of the matching region and without using any tertiary priority, the embodiment of diagram 800 uses both the secondary priority in network function field 806 and the tertiary priority in network function field 808. This is consistent with the use of primary priority links, secondary priority links, and tertiary priority links, as discussed above in connection with diagram 400. Alternatively, in other examples, the system of diagram 800 may only use primary and secondary priority links without using tertiary priority links.

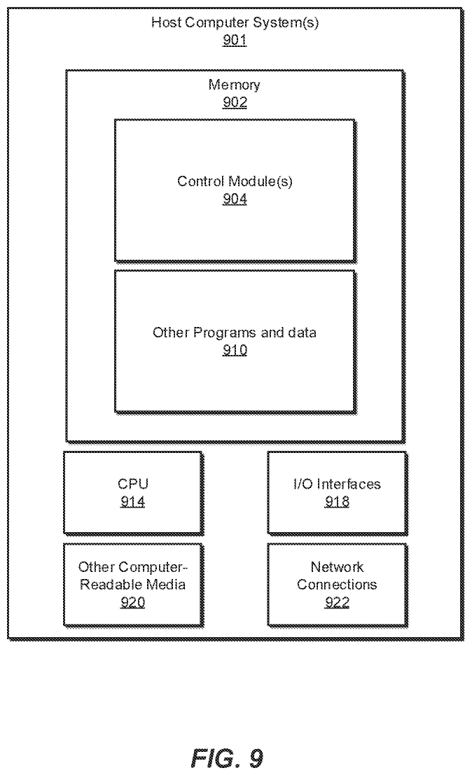

FIG. 9 shows a system diagram that describes an example implementation of a computing system(s) for implementing embodiments described herein. The functionality described herein can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 9 illustrates an example of underlying hardware on which such software and functionality may be hosted and/or implemented.

In particular, shown is example host computer system(s) 901. For example, such computer system(s) 901 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 901 may include memory 902, one or more central processing units (CPUs) 914, I/O interfaces 918, other computer-readable media 920, and network connections 922.

Memory 902 may include one or more various types of non-volatile and/or volatile storage technologies. Examples of memory 902 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 902 may be utilized to store information, including computer-readable instructions that are utilized by CPU 914 to perform actions, including those of embodiments described herein.

Memory 902 may have stored thereon control module(s) 904. The control module(s) 904 may be configured to implement and/or perform some or all of the functions of the systems or components described herein. Memory 902 may also store other programs and data 910, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 922 are configured to communicate with other computing devices to facilitate the functionality described herein. In various embodiments, the network connections 922 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 918 may include a video interface, other data input or output interfaces, or the like. Other computer-readable media 920 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by a home security edge protection proxy at a home cellular network from a visited security edge protection proxy at a visited cellular network, a discovery request from a first network function located at the visited cellular network to discover a second network function within the home cellular network;
inferring, by a component of the home cellular network in response to the discovery request, that the discovery request was sent from a sending region of the visited cellular network despite the discovery request failing to indicate the sending region in a preferred locality field of the discovery request; and
transmitting, by the home security edge protection proxy at the home cellular network to the first network function located at the visited cellular network in response to the discovery request and based on inferring that the discovery request was sent from the sending region of the visited cellular network, a discovery response that indicates a highest priority for at least one candidate network function located at a receiving region of the home cellular network that matches the sending region of the visited cellular network from among a set of multiple pairs of matching regions between the home cellular network and the visited cellular network.

2. The method of claim 1, wherein inferring, by the component of the home cellular network in response to the discovery request, that the discovery request was sent from the sending region of the visited cellular network despite the discovery request failing to indicate the sending region in the preferred locality field of the discovery request comprises the component of the home cellular network inferring the sending region based on analysis of an Internet Protocol address of the home security edge protection proxy.

3. The method of claim 1, further comprising the component of the home cellular network inserting an identifier of the sending region into the discovery request such that a modified discovery request is generated.

4. The method of claim 3, wherein the component of the home cellular network inserts the identifier of the sending region into the preferred locality field of the discovery request such that the modified discovery request is generated.

5. The method of claim 3, wherein the component of the home cellular network inserts the identifier of the sending region into the discovery request such that the modified discovery request is generated at least in part by inserting an identifier of a home security edge protection proxy region where the home security edge protection proxy is located into the discovery request such that the modified discovery request is generated based on an inference that the sending region and the home security edge protection proxy region match each other.

6. The method of claim 3, wherein the home security edge protection proxy at the home cellular network inserts the identifier of the sending region into the discovery request such that the modified discovery request is generated.

7. The method of claim 6, wherein the home security edge protection proxy at the home cellular network forwards the modified discovery request to a home network repository function within the home cellular network.

8. The method of claim 7, wherein the home network repository function within the home cellular network generates the discovery response in response to receiving the modified discovery request.

9. The method of claim 1, wherein the home cellular network checks whether an original region already indicated in a preferred locality field of the discovery request matches the sending region of the visited cellular network that the component of the home cellular network infers the discovery request was sent from.

10. The method of claim 9, wherein the component of the home cellular network overwrites the original region with the sending region in the discovery request based on a conclusion that the original region already indicated in the preferred locality field in the discovery request does not match the sending region of the visited cellular network that the component of the home cellular network infers the discovery request was sent from.

11. The method of claim 1, wherein inferring, by the component of the home cellular network in response to the discovery request, that the discovery request was sent from the sending region of the visited cellular network despite the discovery request failing to indicate the sending region in the preferred locality field of the discovery request comprises the component of the home cellular network inferring the sending region based on analysis of an Internet Protocol address of the visited security edge protection proxy.

12. The method of claim 1, wherein:
the first network function initially sends the discovery request to a visited network repository function in the visited cellular network; and
the visited network repository function in the visited cellular network indicates, in response to receiving the discovery request, that the visited network repository function cannot properly answer the discovery request.

13. The method of claim 12, wherein:
the visited network repository function in the visited cellular network redirects the discovery request to a home network repository function in the home cellular network; and
the visited security edge protection proxy at the visited cellular network, in response to the visited network repository function in the visited cellular network redirecting the discovery request to the home network repository function in the home cellular network, forwards the discovery request to the home security edge protection proxy at the home cellular network.

14. The method of claim 1, wherein the set of multiple pairs of matching regions comprises:
W2 or west;
E2 or central; and
E1 or east.

15. The method of claim 1, wherein:
the home cellular network maintains a respective security edge protection proxy for each region in the set of multiple pairs of matching regions; and
the visited cellular network maintains a respective security edge protection proxy for each region in the set of multiple pairs of matching regions.

16. The method of claim 15, wherein:
each respective security edge protection proxy in the set of multiple pairs of matching regions in the home cellular network connects to all respective security edge protection proxies in the set of multiple pairs of matching regions in the visited cellular network; and
each respective security edge protection proxy in the set of multiple pairs of matching regions in the visited cellular network connects to all respective security edge protection proxies in the set of multiple pairs of matching regions in the home cellular network.

17. A system comprising:
at least one physical computing processor of a computing device; and
a non-transitory computer-readable medium that has instructions stored thereon that, when executed by the at least one physical computing processor, cause the computing device to perform operations comprising:
receiving, by a home security edge protection proxy at a home cellular network from a visited security edge protection proxy at a visited cellular network, a discovery request from a first network function located at the visited cellular network to discover a second network function within the home cellular network;
inferring, by a component of the home cellular network in response to the discovery request, that the discovery request was sent from a sending region of the visited cellular network despite the discovery request failing to indicate the sending region in a preferred locality field of the discovery request; and
transmitting, by the home security edge protection proxy at the home cellular network to the first network function located at the visited cellular network in response to the discovery request and based on inferring that the discovery request was sent from the sending region of the visited cellular network, a discovery response that indicates a highest priority for at least one candidate network function located at a receiving region of the home cellular network that matches the sending region of the visited cellular network from among a set of multiple pairs of matching regions between the home cellular network and the visited cellular network.

18. The system of claim 17, wherein inferring, by the component of the home cellular network in response to the discovery request, that the discovery request was sent from the sending region of the visited cellular network despite the discovery request failing to indicate the sending region in the preferred locality field of the discovery request comprises the component of the home cellular network inferring the sending region based on analysis of an Internet Protocol address of the home security edge protection proxy.

19. A non-transitory computer-readable medium that has instructions stored thereon that, when executed by at least one physical computing processor, cause a computing device to perform operations comprising:
receiving, by a home security edge protection proxy at a home cellular network from a visited security edge protection proxy at a visited cellular network, a discovery request from a first network function located at the visited cellular network to discover a second network function within the home cellular network;
inferring, by a component of the home cellular network in response to the discovery request, that the discovery request was sent from a sending region of the visited cellular network despite the discovery request failing to indicate the sending region in a preferred locality field of the discovery request; and
transmitting, by the home security edge protection proxy at the home cellular network to the first network function located at the visited cellular network in response to the discovery request and based on inferring that the discovery request was sent from the sending region of the visited cellular network, a discovery response that indicates a highest priority for at least one candidate network function located at a receiving region of the home cellular network that matches the sending region of the visited cellular network from among a set of multiple pairs of matching regions between the home cellular network and the visited cellular network.

20. A non-transitory computer-readable medium of claim 19, wherein inferring, by the component of the home cellular network in response to the discovery request, that the discovery request was sent from the sending region of the visited cellular network despite the discovery request failing to indicate the sending region in the preferred locality field of the discovery request comprises the component of the home cellular network inferring the sending region based on analysis of an Internet Protocol address of the home security edge protection proxy.
